(19) United States
(12) Patent Application Publication
(10) Pub. No.: US 2026/0099066 A1
(43) Pub. Date: Apr. 9, 2026

(54) LENS STACK WITH MECHANICAL DELAMINATION RESISTANT FEATURES

(71) Applicant: Applied Materials, Inc., Santa Clara, CA (US)

(72) Inventors: Daniel ADEMA, Kitchener (CA); Kazuya DAITO, Milpitas, CA (US); Neal RICKS, San Jose, CA (US)

(21) Appl. No.: 19/345,148

(22) Filed: Sep. 30, 2025

Related U.S. Application Data
(60) Provisional application No. 63/702,784, filed on Oct. 3, 2024.

(51) Int. Cl. G02C 9/04; G02B 27/01; G02C 7/08

(52) U.S. Cl. CPC G02C 9/04; G02B 27/0176; G02C 7/086; G02B 2027/0178; G02C 2200/10; G02C 2200/14; G02C 2202/16

(57) ABSTRACT

An ophthalmic lens is provided. The ophthalmic lens includes a lens stack having an eye-side (ES) lens, a world-side (WS) lens, a waveguide disposed between the ES lens and the WS lens, and one or more adhesive layers securing at least the ES lens to the waveguide and at least the WS lens to the waveguide. Further, the ophthalmic lens includes a retainer engaging the ES lens and the WS lens and being arranged to mechanically hold the lens stack together and resist delamination forces of the lens stack.

### CROSS-REFERENCE TO RELATED APPLICATIONS

This application claims the benefit of US provisional application number 63/702,784, filed October 3, 2024, which is incorporated herein by reference in its entirety.

### BACKGROUND

### Field

Embodiments of the present disclosure generally relate to ophthalmic lenses.

### Description of the Related Art

Virtual reality is generally considered to be a computer-generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

Typically, lens-stack assemblies with plano-surface lenses have an air gap thickness that is set by the adhesive bond-line thickness. In order to ensure the total-internal-reflection (TIR) over the full range of environmental conditions, a larger air gap is needed. A larger adhesive bond-line thickness, however, may undermine the adhesive reliability. Reliability expectations of AR lens-stack assemblies can be demanding. For instance, high thermal ranges present challenges for preventing adhesive delamination. Some solutions for adhesive delamination resistance have relied on the properties and (planar) geometry of the adhesive interface.

Accordingly, there is a need for improved ophthalmic lenses with delamination resistant features.

### SUMMARY

The present disclosure generally relates to ophthalmic lenses. More particularly, the present disclosure provides embodiments relating to an ophthalmic lens having features that mechanically retain a lens stack thereof.

In one aspect, an ophthalmic lens is provided. The ophthalmic lens includes a lens stack that includes an eye-side (ES) lens; a world-side (WS) lens; a waveguide disposed between the ES lens and the WS lens; and one or more adhesive layers securing at least the ES lens to the waveguide and at least the WS lens to the waveguide. Further, the ophthalmic lens includes a retainer engaging the ES lens and the WS lens and being arranged to mechanically hold the lens stack together.

In another aspect, an ophthalmic lens is provided. The ophthalmic lens includes a lens stack having an eye-side (ES) lens; a world-side (WS) lens; a waveguide disposed between the ES lens and the WS lens, an ES air gap being defined between the ES lens and the waveguide and a WS air gap being defined between the WS lens and the waveguide; an ES adhesive disposed in the ES air gap and securing the ES lens to the waveguide; and a WS adhesive disposed in the WS air gap and securing the WS lens to the waveguide. Further, the ophthalmic lens includes a retainer having a first retainer arm engaging the ES lens and a second retainer arm engaging the WS lens, the first retainer arm and the second retainer arm being arranged to mechanically hold the lens stack together.

In yet another aspect, an ophthalmic lens is provided. The ophthalmic lens includes a lens stack having an eye-side (ES) lens; a world-side (WS) lens; a waveguide disposed between the ES lens and the WS lens; and one or more adhesive layers securing at least the ES lens to the waveguide and at least the WS lens to the waveguide. In addition, the ophthalmic lens includes a retainer received within a through hole defined collectively at least by the ES lens, the one or more adhesive layers, and the WS lens, the retainer having at least one end that has a larger cross-sectional area than does the through hole at some position along a long axis of the through hole.

In a further aspect, an ophthalmic lens is provided. The ophthalmic lens includes a lens stack having an eye-side (ES) lens; a world-side (WS) lens; a waveguide disposed between the ES lens and the WS lens; and one or more adhesive layers securing at least the ES lens to the waveguide and at least the WS lens to the waveguide. The ophthalmic lens also includes a means for applying a compressive force on the lens stack to mechanically hold the lens stack together. The means can be any of the retainers disclosed herein.

In yet a further aspect, an ophthalmic lens is provided. The ophthalmic lens includes a lens stack having an eye-side (ES) lens; a world-side (WS) lens; a waveguide disposed between the ES lens and the WS lens; and one or more adhesive layers securing at least the ES lens to the waveguide and at least the WS lens to the waveguide. In addition, the ophthalmic lens includes a means for shifting a loading mode on the lens stack from a peel loading mode to a tensile loading mode. As one example, the means can be the retainer of FIG. 9. As another example, the means can be the retainer of FIG. 11.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only examples and are therefore not to be considered limiting of its scope, as the disclosure may provide other equally effective embodiments.

FIG. 1 is a schematic, cross-sectional view of a portion of an ophthalmic lens, according to one or more embodiments of the present disclosure.

FIG. 2 is a schematic perspective view of the ophthalmic lens of FIG. 1.

FIG. 3 is a schematic, cross-sectional view taken along line A-A in FIG. 2.

FIG. 4 is a side view of a retainer of the ophthalmic lens of FIG. 1.

FIG. 5 is a side view of a retainer for an ophthalmic lens, according to one or more embodiments of the present disclosure.

FIG. 6 is a perspective view of a retainer for an ophthalmic lens, according to one or more embodiments of the present disclosure.

FIG. 7 is a perspective view of a retainer for an ophthalmic lens, according to one or more embodiments of the present disclosure.

FIG. 8 depicts an ophthalmic lens disposed in a frame, according to one or more embodiments of the present disclosure.

FIG. 9 is a schematic, cross-sectional view of a portion of an ophthalmic lens, according to one or more embodiments of the present disclosure.

FIG. 10 depicts the ophthalmic lens of FIG. 9 disposed in a frame.

FIG. 11 is a schematic, cross-sectional view of a portion of an ophthalmic lens, according to one or more embodiments of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure provides embodiments relating to an ophthalmic lens having mechanical features that retain a lens stack thereof (e.g., an augmented reality (AR) lens stack) and provide resistance to delamination of one or more adhesive layers. Such features can be arranged along a perimeter of the lens stack, e.g., strategically in higher peel stress regions. In some example aspects, such mechanical features can be added to an ophthalmic lens stack assembly (such as external spring clips, pins, rivets, etc.) to locally resist delamination. Other mechanical features (e.g., holes, grooves, slots, etc.) can be added to enable integration of the external mechanical features and/or to enable additional adhesive load paths to connect world-side (WS) and eye-side (ES) lenses and/or to change the loading mode, such as changing the loading mode from peel to tensile.

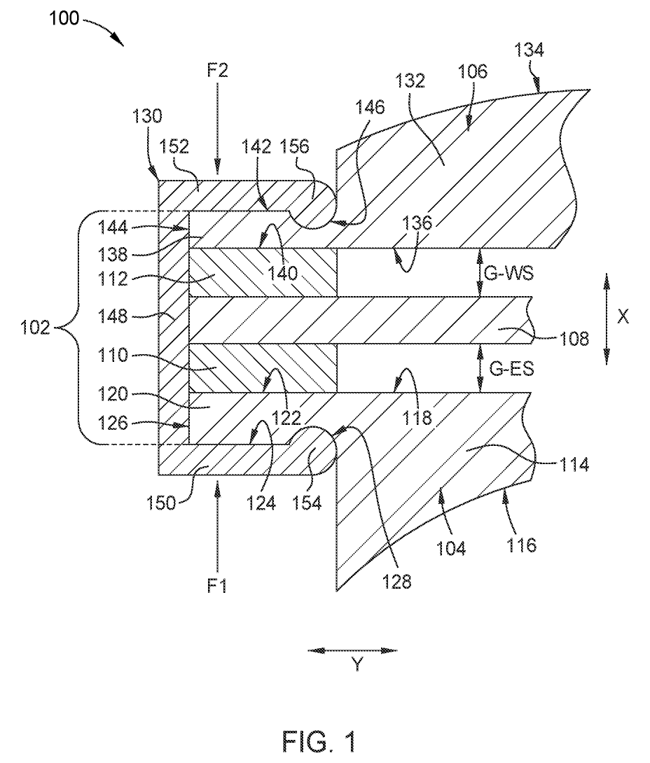

FIG. 1 is a schematic, cross-sectional view of a portion of an ophthalmic lens 100, according to one or more embodiments of the present disclosure. More specifically, FIG. 1 depicts a close-up view of an edge of a lens stack 102 of the ophthalmic lens 100.

The ophthalmic lens 100 has an eye-side (ES) lens, or ES lens 104, a world-side (WS) lens, or WS lens 106, and a waveguide 108 disposed between the ES lens 104 and the WS lens 106. The ophthalmic lens 100 also includes one or more adhesive layers securing at least the ES lens 104 to the waveguide 108 and at least the WS lens 106 to the waveguide 108. In the illustrative embodiment of FIG. 1, the one or more adhesive layers include an ES adhesive 110 securing the ES lens 104 to the waveguide 108. The ES adhesive 110 is disposed within an ES air gap G-ES defined between the ES lens 104 and the waveguide 108. Further, the one or more adhesive layers include a WS adhesive 112 securing the WS lens 106 to the waveguide 108. The WS adhesive 112 is disposed within a WS air gap G-WS defined between the WS lens 106 and the waveguide 108. The ES lens 104, the ES adhesive 110, the waveguide 108, the WS adhesive 112, and the WS lens 106 collectively form the lens stack 102. These components are stacked along a first direction X. The adhesive layers can be formed of any suitable adhesive.

The ES lens 104 has an ES main body 114 having an ES curved surface 116 and an ES planar surface 118 opposing the ES curved surface 116. The ES curved surface 116 is concave in this example. An ES shelf 120 protrudes or extends from the ES main body 114, e.g., in a second direction Y, which is perpendicular to the first direction X. The ES shelf 120 has an ES inner surface 122 and an ES outer surface 124 opposing the ES inner surface 122. An end surface 126 extends between and connects the ES inner surface 122 and the ES outer surface 124. The ES inner surface 122 is an adhesive-facing surface and thus the ES adhesive 110 adheres to the ES inner surface 122 of the ES shelf 120. In some embodiments, the ES outer surface 124 defines or forms a retention detent 128, e.g., which is arranged to receive a protrusion of a retainer 130, as will be explained further below.

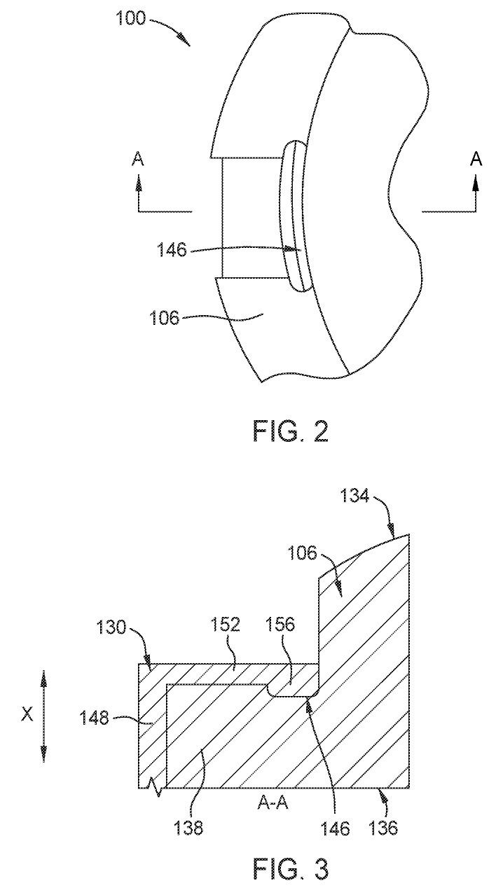

The WS lens 106 has a WS main body 132 having a WS curved surface 134 and a WS planar surface 136 opposing the WS curved surface 134. The WS curved surface 134 is convex in this example. A WS shelf 138 protrudes or extends from the WS main body 132, e.g., in the second direction Y. The WS shelf 138 has a WS inner surface 140 and a WS outer surface 142 opposing the WS inner surface 140. An end surface 144 extends between and connects the WS inner surface 140 and the WS outer surface 142. The WS inner surface 140 is an adhesive-facing surface and thus the WS adhesive 112 adheres to the WS inner surface 140 of the WS shelf 138. In some embodiments, the WS outer surface 142 defines or forms a retention detent 146, e.g., which is arranged to receive a protrusion of the retainer 130. FIG. 2 and FIG. 3 show the retention detent 146 formed by the WS shelf 138 of the WS lens 106.

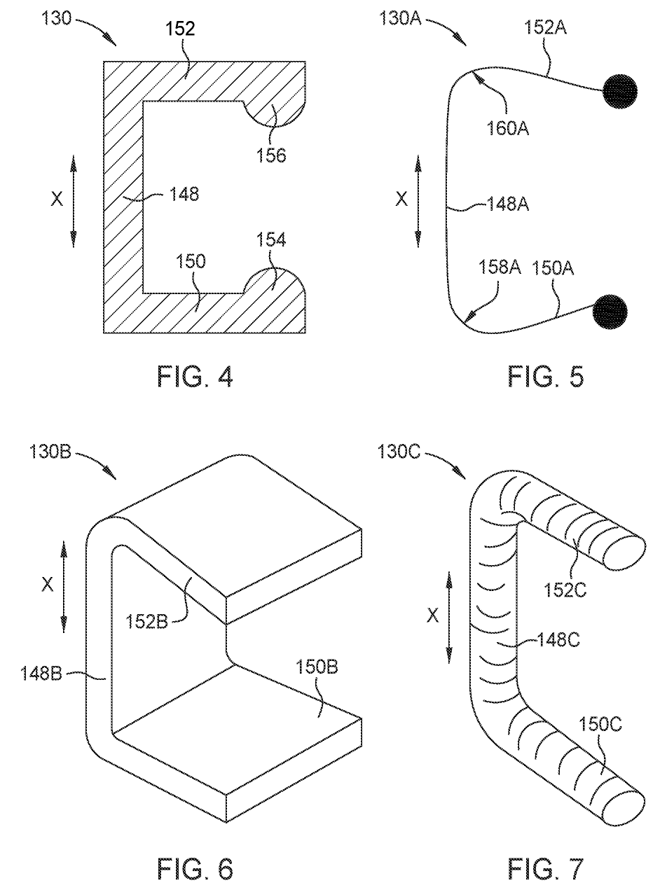

The ophthalmic lens 100 also includes the retainer 130 that engages the ES lens 104 and the WS lens 106 and is arranged to mechanically hold the lens stack 102 together. That is, the retainer 130 mechanically retains the lens stack 102 together to resist delamination forces at the edge of the lens stack 102. In this way, delamination of the adhesive layers from the lenses can be resisted. For the depicted embodiment of FIG. 1, the retainer 130 has a C-shaped cross-sectional profile and includes a backbone 148, a first retention arm 150 extending from one end of the backbone 148, and a second retention arm 152 extending from the other end of the backbone 148. The retainer 130 can be made of various materials, such as steel. The first retention arm 150 includes a first protrusion 154 at its distal end and the second retention arm 152 includes a second protrusion 156 at its distal end. The first protrusion 154 and the second protrusion 156 face toward one another. FIG. 4 provides a close-up side view of the retainer 130 depicted in FIG. 1.

As depicted in FIG. 1, when the retainer 130 is arranged in place to mechanically retain the lens stack 102, the first retention arm 150 engages the ES outer surface 124 of the ES shelf 120 and the first protrusion 154 is received in the retention detent 128. The locating of the first protrusion 154 in the retention detent 128 can facilitate registration and retention of the retainer 130. Similarly, the second retention arm 152 engages the WS outer surface 142 of the WS shelf 138 and the second protrusion 156 is received in the retention detent 146. The locating of the second protrusion 156 in the retention detent 146 can facilitate registration and retention of the retainer 130. The first protrusion 154 and the second protrusion 156 can thus respectively “grip” the ES lens 104 and the WS lens 106.

In some embodiments, the first retention arm 150 engages the ES outer surface 124 of the ES shelf 120 and applies a force F1 on the lens stack 102, e.g., in an eye-to-world direction along the first direction X. Similarly, the second retention arm 152 engages the WS outer surface 142 of the WS shelf 138 and applies a force F2 on the lens stack 102, e.g., in a world-to-eye direction along the first direction X. The eye-to-world and world-to-eye directions are opposite directions along the first direction X. Thus, the forces F1, F2 oppose one another and provide compressive forces on the lens stack 102. In this way, delamination of the adhesive layers is resisted or prevented. For instance, the peeling of the adhesive layers from the lenses when subjected to thermal stresses can be resisted or prevented by the retainer 130. With use of the retainer 130, the loads into the one or more adhesive layers can be reduced.

Further, the backbone 148 can maintain alignment and position of the components of the lens stack 102. As illustrated in FIG. 1, the backbone 148 can engage the end surfaces of: the ES lens 104, the ES adhesive 110 securing the ES lens 104 to the waveguide 108, the waveguide 108, the WS adhesive 112 securing the WS lens 106 to the waveguide 108, and the WS lens 106. In this example embodiment, the retainer 130 protrudes beyond the lens stack 102 along the second direction Y. Accordingly, the backbone 148 wraps or traverses around the lens stack 102.

In some embodiments, the retainer 130 of FIGS. 1 and 4 can have a different configuration. Example retainers are provided below.

FIG. 5 depicts a retainer 130A that can be used to mechanically retain the lens stack 102 of the ophthalmic lens 100 of FIGS. 1, 2, and 3. The retainer 130A of FIG. 5 is arranged with a spring-force preload. The retainer 130A has a first retention arm 150A, a second retention arm 152A, and a backbone 148A extending between and connecting the first retention arm 150A and the second retention arm 152A. A first curved portion 158A transitions the backbone 148A to the first retention arm 150A and a second curved portion 160A transitions the backbone 148A to the second retention arm 152A.

The first retention arm 150A and the second retention arm 152A converge toward one another as they (i.e., the first retention arm 150A and the second retention arm 152A) extend away from the backbone 148A. In this manner, when the retainer 130A is positioned in place to mechanically retain a lens stack, the first retention arm 150A and the second retention arm 152A engage the ES and WS lenses respectively and are moved from their respective neutral states, in which the first retention arm 150A and the second retention arm 152A converge toward one another as they extend away from the backbone 148A, to respective extended states, in which the first retention arm 150A and the second retention arm 152A either do not converge or have less convergence than when in their respective neutral states. Thus, when “clipped” onto the lens stack, the first retention arm 150A and the second retention arm 152A seek to return to their respective neutral states, which applies compressive forces on the lens stack to hold the lens stack together.

FIG. 6 depicts a retainer 130B that can be used to mechanically retain the lens stack 102 of the ophthalmic lens 100 of FIGS. 1, 2, and 3. The retainer 130B of FIG. 6 is arranged as a steel C-clip. The retainer 130B has a first retention arm 150B, a second retention arm 152B, and a backbone 148B extending between and connecting the first retention arm 150B and the second retention arm 152B. A first curved portion transitions the backbone 148B to the first retention arm 150B and a second curved portion transitions the backbone 148 to the second retention arm 152B. Although not shown, in some embodiments, the first retention arm 150B and the second retention arm 152B can both include protrusions receivable within respective detents of the lenses. The protrusions can be respectively arranged at the distal ends of the first retention arm 150B and the second retention arm 152B.

In at least some example aspects, the first retention arm 150B and the second retention arm 152B can converge toward one another as they (i.e., the first retention arm 150B and the second retention arm 152B) extend away from the backbone 148B. In this way, much like the retainer 130A of FIG. 5, the retainer 130B of FIG. 6 can apply compressive forces on the lens stack to hold the lens stack together.

FIG. 7 depicts a retainer 130C that can be used to mechanically retain the lens stack 102 of the ophthalmic lens 100 of FIGS. 1, 2, and 3. The retainer 130C of FIG. 7 is arranged as a wireform C-clip. The retainer 130C has a first retention arm 150C, a second retention arm 152C, and a backbone 148C extending between and connecting the first retention arm 150C and the second retention arm 152C. A first curved portion transitions the backbone 148C to the first retention arm 150C and a second curved portion transitions the backbone 148C to the second retention arm 152C. Although not shown, in some embodiments, the first retention arm 150C and the second retention arm 152C can both include protrusions receivable within respective detents of the lenses. The protrusions can be respectively arranged at the distal ends of the first retention arm 150C and the second retention arm 152C.

In at least some example aspects, the first retention arm 150C and the second retention arm 152C can converge toward one another as they (i.e., the first retention arm 150C and the second retention arm 152C) extend away from the backbone 148C. In this way, much like the retainer 130A of FIG. 5, the retainer 130C of FIG. 7 can apply compressive forces on the lens stack to hold the lens stack together.

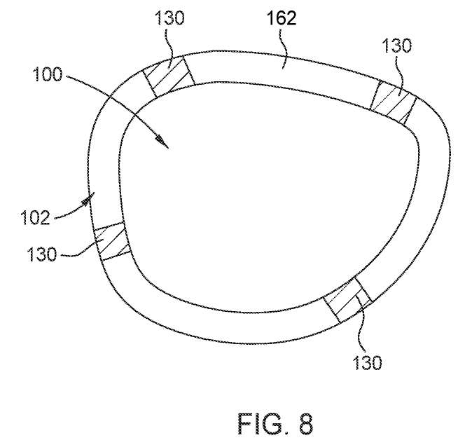

FIG. 8 depicts the ophthalmic lens 100 of FIG. 1 incorporated into a frame 162. As shown in FIG. 8, the lens stack 102 of the ophthalmic lens 100 is held together by the retainer 130, which is one of a plurality of retainers in this example. The plurality of retainers (each labeled 130 in FIG. 8) can be spaced from one another about a perimeter of the lens stack 102, and can be hidden by the frame 162. Spacing the plurality of retainers about the lens stack 102 can distribute stress more uniformly throughout the lens stack 102 and the frame 162. Further, the working length of CTE mismatch (or coefficient of thermal expansion mismatch) between the components of the lens stack 102 and/or between the components of the lens stack 102 and the frame 162 can be reduced. Stated another way, the length of the adhesive joint under load can be reduced. In some embodiments, the plurality of retainers can be evenly spaced from one another along a perimeter the lens stack 102. In other embodiments, the plurality of retainers can have other suitable spacing between each other along the perimeter of the lens stack 102.

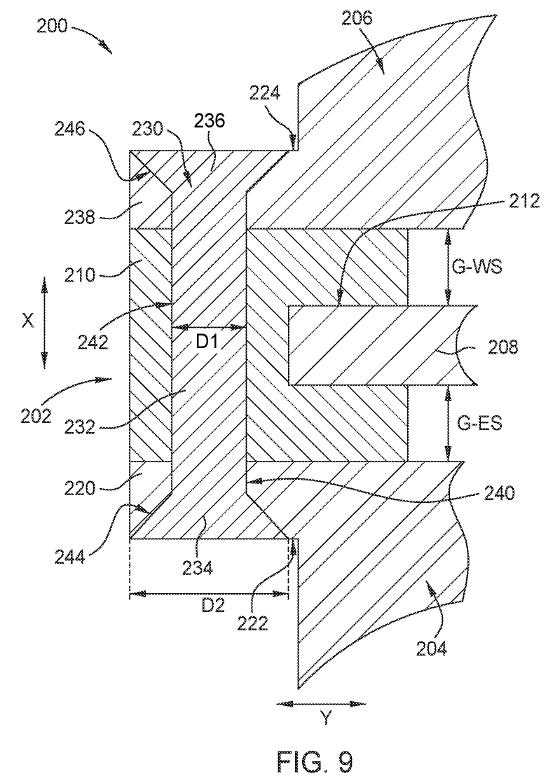

FIG. 9 is a schematic, cross-sectional view of a portion of an ophthalmic lens 200, according to one or more embodiments of the present disclosure. More specifically, FIG. 9 depicts a close-up view of an edge of a lens stack 202 of the ophthalmic lens 200.

The ophthalmic lens 200 has an ES lens 204, a WS lens 206, and a waveguide 208 disposed between the ES lens 204 and the WS lens 206. The ophthalmic lens 200 also includes one or more adhesive layers securing at least the ES lens 204 to the waveguide 208 and at least the WS lens 206 to the waveguide 208. In the illustrative embodiment of FIG. 9, the one or more adhesive layers include an adhesive 210 that extends between and engages the ES lens 204 and the WS lens 206 and defines a recess 212 in which at least a portion of the waveguide 208 is received. At least a portion of the adhesive 210 is disposed within an ES air gap G-ES defined between the ES lens 204 and the waveguide 208 and at least a portion of the adhesive 210 is disposed within a WS air gap G-WS defined between the WS lens 206 and the waveguide 208. The ES lens 204, the adhesive 210, the waveguide 208, and the WS lens 206 collectively form the lens stack 202. These components are stacked along a first direction X.

The ES lens 204 has an ES main body having an ES curved surface and an ES planar surface opposing the ES curved surface. The ES curved surface is concave in this example. An ES shelf 220 protrudes or extends from the ES main body, e.g., in a second direction Y, which is perpendicular to the first direction X. The ES shelf 220 has an ES inner surface and an ES outer surface 222 opposing the inner surface. An end surface extends between and connects the ES inner surface and the ES outer surface 222. The ES inner surface is an adhesive-facing surface and thus the adhesive 210 adheres to the ES inner surface of the ES shelf 220, as well as to a portion of the ES planar surface of the ES main body.

The WS lens 106 has a WS main body having a WS curved surface and a WS planar surface opposing the WS curved surface. The WS curved surface is convex in this example. A WS shelf 238 protrudes or extends from the WS main body, e.g., in the second direction Y. The WS shelf 238 has a WS inner surface and a WS outer surface 224 opposing the WS inner surface. An end surface extends between and connects the WS inner surface and the WS outer surface 224. The WS inner surface is an adhesive-facing surface and thus the adhesive 210 adheres to the WS inner surface of the WS shelf 238, as well as to a portion of the WS planar surface of the WS main body.

As further depicted in FIG. 9, a through hole 240 is defined or formed through components of the lens stack 202. Specifically, the through hole 240 is defined or formed, at least in part, by the ES lens 204, the adhesive 210, and the WS lens 206, or more specifically still, by the ES shelf 220 of the ES lens 204, the adhesive 210, and the WS shelf 238 of the WS lens 206.

In this example embodiment, the ES shelf 220 and the WS shelf 238 protrude or extend further out than the waveguide 208, e.g., along the second direction Y. As shown in FIG. 9, the end surface of the waveguide 208 is aligned with or substantially coplanar with the proximal ends of the ES shelf 220 and the WS shelf 238 where they respectively connect to their main bodies. Accordingly, in this example, advantageously, the through hole 240 does not extend through the waveguide 208, which in some embodiments can be formed of a brittle material. The through hole 240 can be formed, for example, by aligning the ES lens 204, the adhesive 210, and the WS lens 206 and then drilling the through hole 240.

Further, for the depicted embodiment of FIG. 9, the through hole 240 has a varying diameter along its long axis, which extends along the first direction X. Specifically, the through hole 240 has a shank portion 242 flanked on both sides by ES and WS countersink ends 244, 246. The shank portion 242 has a first diameter D1. At the ES countersink end 244, the first diameter D1 gradually increases to a second diameter D2. Similarly, at the WS countersink end 246, the first diameter D1 gradually increases to the second diameter D2. The ES and WS countersink ends 244, 246 are defined or formed by the ES shelf 220 and the WS shelf 238, respectively.

The ophthalmic lens 200 also includes a retainer 230 that engages the ES lens 204 and the WS lens 206 and is arranged to mechanically hold the lens stack 202 together. That is, the retainer 230 mechanically retains the lens stack 202 together to resist delamination forces at the edge of the lens stack 202. In this way, delamination of the adhesive layers from the lenses can be resisted. For the depicted embodiment of FIG. 9, the retainer 230 is a rivet. The rivet has a shank portion 232 flanked on both sides by countersunk ends 234, 236. The countersunk ends 234, 236 can each have conical frustum shapes as depicted in FIG. 9. The shank portion 232 of the rivet is received within the shank portion 242 of the through hole 240 while the countersunk ends 234, 236 are received respectively within theES and WS countersink ends 244, 246 of the through hole 240 as depicted in FIG. 9. The rivet can be received within the through hole 240 so that a first end of the rivet is flush with the ES outer surface 222 of the ES shelf 220 and so that a second end of the rivet is flush with the WSouter surface 224 of theWS shelf 238. The rivet does not extend through the waveguide 208 in the illustrated embodiment of FIG. 9. However, in other embodiments, the rivet can extend through the waveguide 208.

As noted above, the retainer 230, in this example a rivet, is arranged to mechanically hold the lens stack 202 together. The rivet can be arranged in such a way to change some of the peel loading of the adhesive from the lenses to tensile loading. Particularly, when the ES lens 204 and WSlens 206 are stressed such that one or more forces are acting to attempt to pull them apart from one another, the adhesive 210 may attempt to peel from the ES lens 204 and/or the WS lens 206. The rivet can be arranged to resist these forces and can withstand tensile loading. Specifically, the countersunk ends 234, 236 of the rivet can resist these forces by engaging the walls of the ES lens 204 and the WSlens 206 at the ES and WS countersink ends 244, 246 of the through hole 240. These surfaces can act in shear, thereby removing at least some the loading away from the adhesive joints. Moreover, pulling or attempting to pull one of the countersunk ends 234, 236 into or through the shank portion 242 of the through hole 240 presents a challenge as the countersunk ends 234, 236 each have a larger diameter than the shank portion 242 of the through hole 240. In this way, the rivet can hold the lens stack 202 together and can provide delamination resistance.

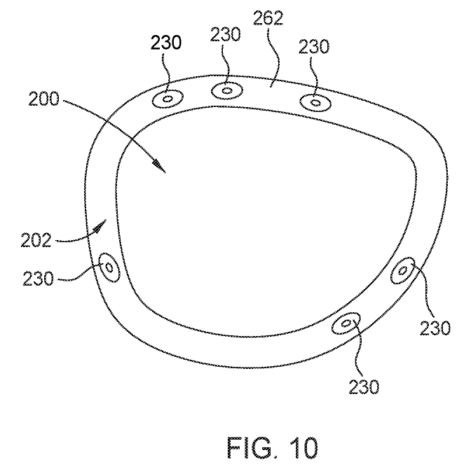

FIG. 10 depicts the ophthalmic lens 200 of FIG. 9 incorporated into a frame 262. As shown in FIG. 10, the lens stack 202 of the ophthalmic lens 200 is held together by the retainer 230, which is one of a plurality of retainers in this example. The plurality of retainers (each labeled 230 in FIG. 10) can be spaced from one another about a perimeter of the lens stack 202, and can be hidden by the frame 262. Spacing the plurality of retainers about the lens stack can distribute stress more uniformly throughout the lens stack 202 and the frame 262. Further, the working length of CTE mismatch (or coefficient of thermal expansion mismatch) between the components of the lens stack 202 and/or between the components of the lens stack 202 and the frame 262 can be reduced. Stated another way, the length of the adhesive joint under load can be reduced. In some embodiments, the plurality of retainers can be evenly spaced from one another along a perimeter of the lens stack 202. In other embodiments, the plurality of retainers can have other suitable spacing between each other along the perimeter of the lens stack 202.

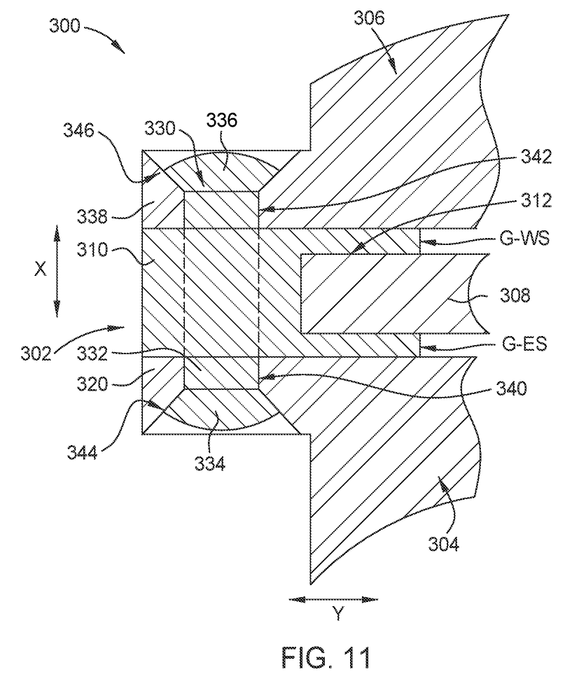

FIG. 11 is a schematic, cross-sectional view of a portion of an ophthalmic lens 300, according to one or more embodiments of the present disclosure. More specifically, FIG. 11 depicts a close-up view of an edge of a lens stack 302 of the ophthalmic lens 300.

The ophthalmic lens 300 has an ES lens 304, a WS lens 306, and a waveguide 308 disposed between the ES lens 304 and the WS lens 306. The ophthalmic lens 300 also includes one or more adhesive layers securing at least theESlens 304 to the waveguide 308 and at least the WS lens 306 to the waveguide 308. In the illustrative embodiment of FIG. 11, the one or more adhesive layers include an adhesive 310 that extends between and engages theESlens 304 and theWS lens 306 and defines a recess 312 in which at least a portion of the waveguide 308 is received. At least a portion of the adhesive 310 is disposed within an ES air gap G-ES defined between the ES lens 304 and the waveguide 308 and at least a portion of the adhesive 310 is disposed within a WSair gap G-WS defined between the WS lens 306 and the waveguide 308. The ES lens 304, the adhesive 310, the waveguide 308, and the WS lens 306 collectively form the lens stack 302. These components are stacked along a first direction X.

TheES lens 304 has an ESmain body having an ES curved surface and an ES planar surface opposing the ES curved surface. The ES curved surface is concave in this example. An ES shelf 320 protrudes or extends from the ES main body, e.g., in a second direction Y, which is perpendicular to the first direction X. The ES shelf 320 has an ES inner surface and an ES outer surface opposing the ES inner surface. An end surface extends between and connects the ESinner surface and theES outer surface. The ES inner surface is an adhesive-facing surface and thus the adhesive 310 adheres to the ES inner surface of the ES shelf 320, as well as to a portion of the ES planar surface of the ES main body.

The WS lens 106 has a WS main body having a WS curved surface and a WS planar surface opposing the WS curved surface. The WS curved surface is convex in this example. A WS shelf 338 protrudes or extends from the WS main body, e.g., in the second direction Y. The WS shelf 338 has a WS inner surface and a WS outer surface opposing the WS inner surface. An end surface extends between and connects the WS inner surface and the WS outer surface. The WS inner surface is an adhesive-facing surface and thus the adhesive 310 adheres to the WS inner surface of the WS shelf 338, as well as to a portion of the WS planar surface of the WS main body. The ES shelf 320 and the WS shelf 338 protrude or extend further out than the waveguide 308, e.g., along the second direction Y.

As further depicted in FIG. 11, a through hole 340 is defined or formed through components of the lens stack 302. Specifically, the through hole 340 is defined or formed, at least in part, by the ES lens 304, the adhesive 310, and the WS lens 306, or more specifically still, by the ES shelf 320 of the ES lens 304, the adhesive 310, and the WS shelf 338 of the WS lens 306.

In this example embodiment, the ES shelf 320 and the WS shelf 338 protrude or extend further out than the waveguide 308, e.g., along the second direction Y. As shown in FIG. 11, the end surface of the waveguide 308 is aligned with or substantially coplanar with the proximal ends of the ES shelf 320 and the WS shelf 338 where they respectively connect to their main bodies. Accordingly, in this example, advantageously, the through hole 340 does not extend through the waveguide 308, which in some embodiments can be formed of a brittle material. The through hole 340 can be formed, for example, by aligning the ES lens 304, the adhesive 310, and the WS lens 306 and then drilling the through hole 340.

Further, for the depicted embodiment of FIG. 11, the through hole 340 has a varying diameter along its long axis, which extends along the first direction X. Specifically, the through hole 340 has a shank portion 342 flanked on both sides by ES and WS countersink ends 344, 346. The shank portion 342 has a first diameter. At the ES countersink end 344, the first diameter gradually increases to a second diameter. Similarly, at the WS countersink end 346, the first diameter gradually increases to the second diameter. The ES and WS countersink ends 344, 346 are defined or formed by the ES shelf 320 and the WS shelf 338, respectively.

The ophthalmic lens 300 also includes a retainer 330 that engages the ES lens 304 and the WS lens 306 and is arranged to mechanically hold the lens stack 302 together. That is, the retainer 330 mechanically retains the lens stack 302 together to resist delamination forces at the edge of the lens stack 302. In this way, delamination of the adhesive layers from the lenses can be resisted. For the depicted embodiment of FIG. 11, the retainer 330 is an adhesive filler. The adhesive layer can be formed of a same material as the adhesive 310 or can be formed of a different material. In at least some example embodiments, the adhesive filler can be formed of an epoxy. The adhesive filler can be injected into the through hole 340.

The adhesive filler has a shank portion 332 flanked on both sides by stoppers 334, 336. The stoppers 334, 336 can each be countersunk with spherical caps or domes, e.g., as shown in FIG. 11. The shank portion 332 of the adhesive filler is received within the shank portion 342 of the through hole 340 while the stoppers 334, 336 are received respectively within the ES and WS countersink ends 344, 346 of the through hole 340 as depicted in FIG. 11. The adhesive filler can be received within the through hole 340 so that a first end of the adhesive filler is flush or sunk within the ES shelf 320 and so that a second end of the adhesive filler is flush with or sunk within the WS shelf 338, e.g., as shown in FIG. 11. The adhesive filler does not extend through the waveguide 308 in the illustrated embodiment of FIG. 11. However, in other embodiments, the adhesive filler can extend through the waveguide 308.

As noted above, the retainer 330, in this example an adhesive filler, is arranged to mechanically hold the lens stack 302 together. The adhesive filler can be arranged in such a way to change some of the peel loading of the adhesive from the lenses to tensile loading. Particularly, when the ES lens 304 and WS lens 306 are stressed such that one or more forces are acting to attempt to pull them apart from one another, the adhesive 310 may attempt to peel from the ES lens 304 and/or the WS lens 306. The adhesive filler can be arranged to resist these forces and can withstand tensile loading. Specifically, the stoppers 334, 336 of the adhesive filler can resist these forces by engaging the walls of the ES lens 304 and the WS lens 306 at the countersink ends 344, 346 of the through hole 340. These surfaces can act in shear, thereby removing at least some the loading away from the adhesive joints. Moreover, pulling one of the stoppers 334, 336 through the shank portion 342 of the through hole 340 presents a challenge as the stoppers 334, 336 each have a larger diameter than the shank portion 342 of the through hole 340. That is, the stoppers 334, 336 each have a larger cross-sectional area than does the through hole 340 at some position along a long axis of the through hole 340 (e.g., a position along the shank portion 342 of the through hole 340). Furthermore, the adhesive filler can also bond with the adhesive 310, which increases the bonding area and further facilitates the transfer of stress loads from peeling to tensile. In this way, the adhesive filler can hold the lens stack 302 together and can provide delamination resistance.

The ophthalmic lens 300 of FIG. 11 can be incorporated into a frame, and the lens stack thereof can be held together a plurality of retainers, such as a plurality of adhesive fillers. The plurality of retainers, or adhesive fillers, can be spaced from one another about a perimeter of the lens stack, and can be hidden by the frame. Spacing the plurality of retainers about the lens stack can distribute stress more uniformly throughout the lens stack and the frame. Further, the working length of CTE mismatch (or coefficient of thermal expansion mismatch) between the components of the lens stack and/or between the components of the lens stack and the frame can be reduced. Stated another way, the length of the adhesive joint under load can be reduced. In some embodiments, the plurality of retainers can be evenly spaced from one another along a perimeter of the lens stack. In other embodiments, the plurality of retainers can have other suitable spacing between each other along the perimeter of the lens stack.

In some embodiments, a lens assembly can include a plurality of retainers having any combination of the retainers disclosed herein arranged on the perimeter of the lens stack.

While the foregoing is directed to embodiments of the present disclosure, other and further embodiments of the disclosure may be devised without departing from the basic scope thereof, and the scope thereof is determined by the claims that follow.

What is claimed is:

1. An ophthalmic lens, comprising:
a lens stack, comprising:
an eye-side (ES) lens;
a world-side (WS) lens;
a waveguide disposed between the ES lens and the WS lens; and
one or more adhesive layers securing at least the ES lens to the waveguide and at least the WS lens to the waveguide; and
a retainer engaging the ES lens and the WS lens and being arranged to mechanically hold the lens stack together.

2. The ophthalmic lens of claim 1, wherein the one or more adhesive layers include an ES adhesive securing the ES lens to the waveguide and disposed within an ES air gap defined between the ES lens and the waveguide.

3. The ophthalmic lens of claim 1, wherein the one or more adhesive layers include a WS adhesive securing the WS lens to the waveguide and disposed within a WS air gap defined between the WS lens and the waveguide.

4. The ophthalmic lens of claim 1, wherein the one or more adhesive layers include an adhesive layer that extends between and engages the ES lens and the WS lens and defines a recess in which at least a portion of the waveguide is received.

5. The ophthalmic lens of claim 1, wherein the ES lens has an ES main body and an ES shelf extending from the ES main body, and the WS lens has a WS main body and a WS shelf extending from the WS main body, and
wherein the ES shelf forms a retention detent and the WS shelf forms a retention detent.

6. The ophthalmic lens of claim 5, wherein the retainer has a first retention arm, a second retention arm, and a backbone extending between and connecting the first retention arm and the second retention arm, and
wherein the first retention arm includes a first protrusion receivable within the retention detent of the ES shelf and the second retention arm includes a second protrusion receivable within the retention detent of the WS shelf.

7. The ophthalmic lens of claim 5, wherein:
the ES shelf has an ES inner surface and an ES outer surface opposing the ES inner surface, and wherein an adhesive layer of the one or more adhesive layers is adhered to the ES inner surface and the ES outer surface defines the retention detent of the ES shelf, and
the WS shelf has a WS inner surface and a WS outer surface opposing the WS inner surface, and wherein an adhesive layer of the one or more adhesive layers is adhered to the WS inner surface and the WS outer surface defines the retention detent of the WS shelf.

8. The ophthalmic lens of claim 1, wherein the retainer has a first retention arm, a second retention arm, and a backbone extending between and connecting the first retention arm and the second retention arm, and
wherein the backbone engages end surfaces of: the ES lens, an ES adhesive securing the ES lens to the waveguide, the waveguide, a WS adhesive securing the WS lens to the waveguide, and the WS lens.

9. The ophthalmic lens of claim 1, wherein the retainer has a first retention arm, a second retention arm, and a backbone extending between and connecting the first retention arm and the second retention arm, and
wherein the first retention arm and the second retention arm converge toward one another as the first retention arm and the second retention arm extend away from the backbone.

10. The ophthalmic lens of claim 1, wherein the retainer is arranged with a spring-force preload.

11. The ophthalmic lens of claim 1, wherein the retainer is a steel C-clip.

12. The ophthalmic lens of claim 1, wherein the retainer is a wireform C-clip.

13. The ophthalmic lens of claim 1, wherein the retainer is one of a plurality of retainers arranged along a perimeter of the lens stack.

14. The ophthalmic lens of claim 1, wherein the retainer is a rivet having opposing ends received within opposing countersink ends of a through hole defined, at least in part, by the WS lens, the one or more adhesive layers, and the ES lens.

15. The ophthalmic lens of claim 1, wherein the retainer is a rivet that does not extend through the waveguide.

16. The ophthalmic lens of claim 1, wherein the retainer is a rivet having a first end and a second end, and wherein the first end is flush with an ES shelf of the ES lens and the second end is flush with a WS shelf of the WS lens.

17. The ophthalmic lens of claim 1, wherein the retainer is an adhesive filler received within a through hole collectively formed by the ES lens, at least one adhesive layer of the one or more adhesive layers, and the WS lens.

18. The ophthalmic lens of claim 17, wherein the adhesive filler has a first end and a second end, and wherein at the first end, the second end, or both the first and second ends, the adhesive filler has a stopper that has a larger cross-sectional area than does the through hole at some position along a long axis of the through hole.

19. An ophthalmic lens, comprising:
a lens stack, comprising:
an eye-side (ES) lens;
a world-side (WS) lens;
a waveguide disposed between the ES lens and the WS lens, an ES air gap being defined between the ES lens and the waveguide and a WS air gap being defined between the WS lens and the waveguide;
an ES adhesive disposed in the ES air gap and securing the ES lens to the waveguide; and
a WS adhesive disposed in the WS air gap and securing the WS lens to the waveguide; and
a retainer having a first retainer arm engaging the ES lens and a second retainer arm engaging the WS lens, the first retainer arm and the second retainer arm being arranged to mechanically hold the lens stack together.

20. An ophthalmic lens, comprising:
a lens stack, comprising:
an eye-side (ES) lens;
a world-side (WS) lens;
a waveguide disposed between the ES lens and the WS lens; and
one or more adhesive layers securing at least the ES lens to the waveguide and at least the WS lens to the waveguide; and
a retainer received within a through hole defined collectively at least by the ES lens, the one or more adhesive layers, and the WS lens, the retainer having at least one end that has a larger cross-sectional area than does the through hole at some position along a long axis of the through hole.
